(19) United States
(12) Patent Application Publication
(10) Pub. No.: US 2013/0088810 A1
(43) Pub. Date: Apr. 11, 2013

(54) MULTILAYER CERAMIC CAPACITOR AND METHOD FOR MANUFACTURING THE SAME

(71) Applicants: Jin Hyuck YANG, Gyeonggi-do (KR); Yong Seok Kim, Gyeonggi-do (KR)

(72) Inventors: Jin Hyuck YANG, Gyeonggi-do (KR); Yong Seok Kim, Gyeonggi-do (KR)

(73) Assignee: SAMSUNG Electro-Mechanics Co., Ltd.

(21) Appl. No.: 13/357,373

(22) Filed: Jan. 24, 2012

(30) Foreign Application Priority Data
Oct. 6, 2011 (KR) 10-2011-0101910

(51) Int. Cl. H01G 4/252; B05D 5/12

(52) U.S. Cl. 361/306.3; 427/79

(57) ABSTRACT

Disclosed herein are a multilayer ceramic capacitor and a method for manufacturing the same. The multilayer ceramic capacitor includes: a capacitor main body having dielectric layers and inner electrodes laminated therein; external electrodes and plating layers formed on a surface of the capacitor main body; and electroless plating layers formed between the external electrodes and the plating layers.

According to the examples of the present invention, the electroless plating layer is formed before the plating layer is formed on the external electrode, thereby solving non-plating problems when the plating layer made of nickel or the like is formed on the external electrode. Therefore, soldering defects due to nickel non-plating or the like can be solved at the time of mounting, and thus, a multilayer ceramic capacitor having high reliability can be provided.

### CROSS REFERENCE(S) TO RELATED APPLICATIONS

This application claims the benefit under 35 U.S.C. Section 119 of Korean Patent Application Serial No. 10-2011-0101910, entitled “Multilayer Ceramic Capacitor and Method for Manufacturing the Same” filed on Oct. 6, 2011, which is hereby incorporated by reference in its entirety into this application.

### BACKGROUND OF THE INVENTION

1. Technical Field

The present invention relates to a multilayer ceramic capacitor and a method for manufacturing the same.

2. Description of the Related Art

Following the trend that a semiconductor device has a small size and high speed/high frequency, a super high-capacity multilayer ceramic capacitor (MLCC) is requested. For this, a ratio of capacitance over size needs to be increased, and thus, a dielectric layer and an inner electrode layer need to be further thinned.

Therefore, crystal particles constituting the dielectric layer are requested to have material properties such as small grains, high relative dielectric constant, and small temperature dependency, and the dielectric layer is requested to be structurally thinned and highly multilayered in order to improve an efficiency of capacitance over volume.

Furthermore, since an MLCC for an electronic product becomes smaller, work for recalling defective products is impossible, and as a result, a high-reliability product is requested, like in an MLCC for an electrical device. Therefore, an Ag-epoxy material is mainly used when an external electrode is formed in a high-reliability product. The reason is that an Ag-epoxy external electrode is more densified than a Cu-paste external electrode, and thus permeation of a plating solution can be prevented at the time of surface treatment, thereby preventing deterioration in reliability, and the Ag-epoxy external electrode has better elasticity than the Cu-paste external electrode, thereby preventing deterioration in reliability against flexure strength.

However, in a case of the Ag-epoxy external electrode, epoxy having no conductivity is largely exposed to the surface thereof, which causes soldering defects due to non-plating defects at the time of mounting, in a case where a current nickel electroplating process is performed (See, FIGS. 1 and 2).

### SUMMARY OF THE INVENTION

An object of the present invention is to provide a multilayer ceramic capacitor having a uniform nickel plating layer without nickel non-plating defects, which can be formed even though nickel electroplating is performed on a surface of an external electrode, and having a structure not causing soldering defects at the time of mounting.

Another object of the present invention is to provide a method for manufacturing the multilayer ceramic capacitor.

According to one exemplary embodiment of the present invention, there is provided a multilayer ceramic capacitor, including: a capacitor main body having dielectric layers and inner electrodes laminated therein; external electrodes and plating layers formed on a surface of the capacitor main body; and electroless plating layers formed between the external electrodes and the plating layers.

The electroless plating layer may have a thickness of 0.1 to 5 μm. 5The electroless plating layer may be formed by using at least one metal selected from the group consisting of Sn, Ni, Cu, Ag, Co, Au, and Pd.

The external electrode may be formed by using at least one metal selected from Cu, Ni, and Ag.

The plating layer may be formed to have plural layers including a nickel plating layer and a tin plating layer.

The plating layer may be formed by using one method selected from electroplating and electroless plating, or both of them.

The multilayer ceramic capacitor may further include connection electrodes formed between the capacitor main body and the external electrodes.

The connection electrode may be formed by using at least one metal selected from Cu, Ni, and Ag.

According to another exemplary embodiment of the present invention, there is provided a method for manufacturing a multilayer ceramic capacitor, including: forming a capacitor main body where dielectric layers and inner electrodes are alternately laminated; firing the capacitor main body; forming external electrodes on a surface of the capacitor main body; forming electroless plating layers on the external electrodes; and forming plating layers on the electroless plating layers.

The electroless plating layer may be formed by using at least one metal selected from the group consisting of Sn, Ni, Cu, Ag, Co, Au, and Pd.

The electroless plating layer may have a thickness of 0.1 to 5 μm.

The method may further include performing a pretreatment process on the external electrodes before the forming of the electroless plating layers.

The method may further include forming connection electrodes on the capacitor main body before the forming of the external electrodes.

### BRIEF DESCRIPTION OF THE DRAWINGS

FIG. 1 shows types of soldering defect due to nickel non-plating with nickel in the related art;

FIG. 2 shows cases where soldering defects are generated due to nickel non-plating as a mold analysis result;

FIG. 3 shows a structure of a multilayer ceramic capacitor according to an exemplary embodiment of the present invention;

FIG. 4 shows a structure of a multilayer ceramic capacitor according to another exemplary embodiment of the present invention; and

FIG. 5 is a test picture of a case where soldering defects are not generated after an electroless plating layer according to the present invention is formed.

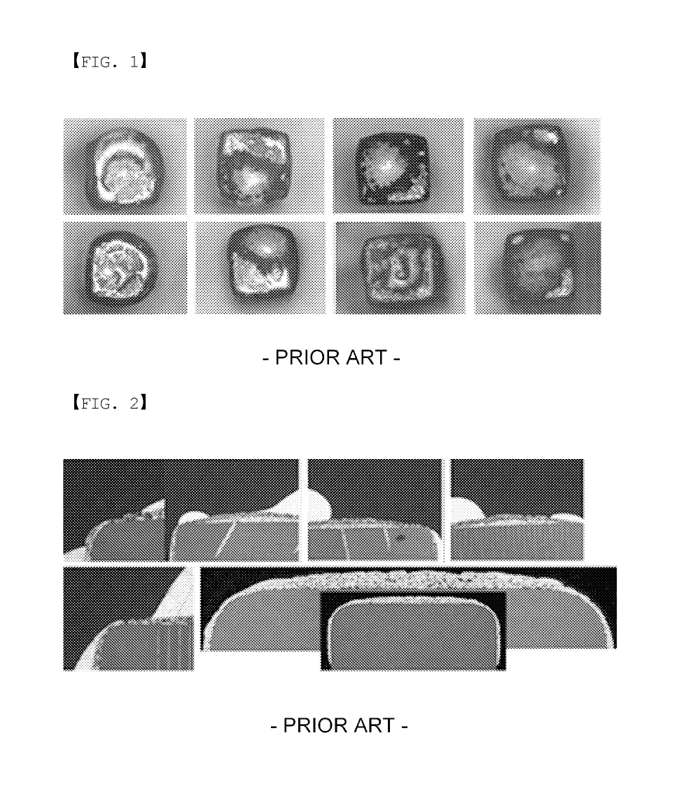

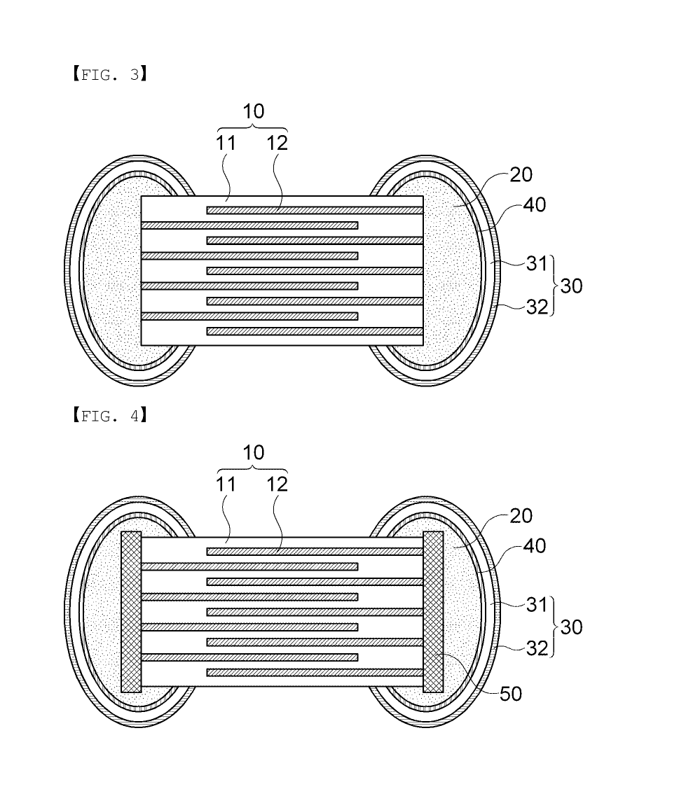

### DESCRIPTION OF THE PREFERRED EMBODIMENTS

Hereinafter, preferred embodiments of the present invention will be described in detail with reference to the accompanying drawings.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

The present invention is directed to a multilayer ceramic capacitor and a method for manufacturing the same.

FIG. 3 shows a structure of a multilayer ceramic capacitor according to one exemplary embodiment of the present invention. Referring to this drawing, the multilayer ceramic capacitor may include a capacitor main body 10 having a plurality of dielectric layers 11 and a plurality of inner electrodes 12 laminated therein, external electrodes 20 formed on a surface of the capacitor main body 10, and plating layers 30. The multilayer ceramic capacitor may further include electroless plating layers 40 formed between the external electrodes 20 and the plating layers 30.

The capacitor main body 10 is a multilayer body including the plurality of dielectric layers 11 and the inner layers 12 having a plurality of layers on the dielectric layers 11, respectively. An end of each of the inner electrode in the capacitor main body 10 is electrically connected to the external electrodes 20 formed on the surface of the capacitor main body 10.

The external electrodes 20 are formed by coating and firing a metal paste including metal components and organic polymer resin on cross sections of the capacitor main body 10. The external electrode 20 of the present invention may be formed by using a metal selected from Cu, Ni, and Ag.

In addition, the plating layer 30 may include a first plating layer 31 and a second plating layer 32. The first plating layer 31 may be formed above the external electrode 20 by using for example Ni as a main component, and the second plating layer 32 may be formed above the first plating layer 31 by using for example Sn as a main component. In other words, the plating layer 30 according to the present invention may be formed in a plurality of layers including the first plating layer 31 (Ni plating layer) and the second plating layer 32 (Sn plating layer).

In addition, in the plating layer 30 according to the present invention, the first plating layer 31 and the second plating layer 32 may be formed by using one method selected from electroplating and electroless plating, or both of the methods.

In general, in a case of Ag-epoxy paste used as a material for the external electrode 20, soldering defects may be easily generated because the first plating layer 31 containing for example Ni as a main component is not sufficiently plated when the plating layer 30 is formed.

In order to solve this problem, the present invention is characterized in that the electroless plating layer 40 is formed on the external electrode 20 before the plating layer 30 is formed.

The electroless plating layer 40 according to the present invention may be formed by using at least one metal selected from the group consisting of Sn, Ni, Cu, Ag, Co, Au, and Pd. Among them, it is preferable to use Sn having good flexibility to improve flexure strength.

The electroless plating layer preferably has a thickness of about 0.1 to 5 μm. If the thickness thereof is below 0.1 μm, a uniform plating layer is difficult to form, with the result that an epoxy portion may be exposed. If the thickness thereof is above 5 μm, adhesion between the electroless plating layer and the capacitor main body may be deteriorated due to deformation and stress of the electroless plating layer at the time of mounting.

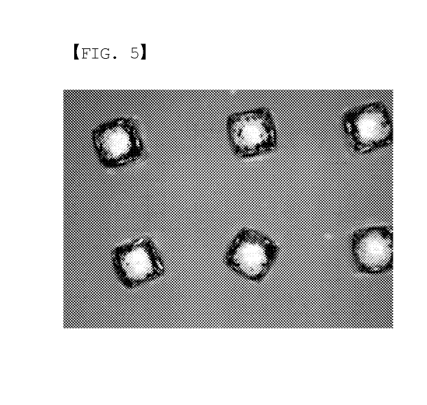

FIG. 4 shows a structure of a multilayer ceramic capacitor according to another exemplary embodiment of the present invention. Referring to this drawing, the multilayer ceramic capacitor may include a capacitor main body 10 having a plurality of dielectric layers 11 and a plurality of inner electrodes 12 laminated therein, external electrodes 20 formed on a surface of the capacitor main body 10, electroless plating layers 40 formed between the external electrodes 20 and the plating layers 30, and electroless plating layers 40 formed on the plating layers 30. The multilayer ceramic capacitor may further include connection electrodes 50 for improving contact performance between the inner electrodes 12 and the external electrodes 20.

The connection electrode may be formed by using at least one metal selected from Cu, Ni, and Ag.

A method for manufacturing the multilayer ceramic capacitor of the present invention having the above structure will be described as follows.

First, as a first stage, a capacitor main body where a plurality of dielectric layers and a plurality of inner electrodes are alternately laminated is formed.

The dielectric layer is formed in a sheet type, by mixing a dielectric ceramic powder, a binder, and a solvent to prepare a slurry and coating the slurry through a doctor blade method or the like. The plurality of inner electrodes are formed on surfaces of the dielectric layers respectively, thereby manufacturing a capacitor main body having inner electrode patterns.

The inner electrode is formed by coating a paste, where powder made of Ni or Ni alloy is dispersed in the organic binder and the solvent. A metal for the Ni alloy may contain Mn, Cr, Co or Al.

As the organic binder, any material known to the art may be used, and a binder of, for example, without being limited thereto, a cellulose based resin, an epoxy resin, an aryl resin, an acrylic resin, a phenol-formaldehyde resin, an unsaturated polyester resin, a polycarbonate resin, a polyamide resin, a polyimide resin, an alkyd resin, rosin ester, or the like may be used.

Also, as the organic solvent, any material known to the art may be used, and a solvent of, for example, without being limited thereto, butylcarbitol, butylcarbitol acetate, terpene oil, α-terpineol, ethyl cellosolve, butyl phthalate, or the like may be used.

The capacitor main body where the plurality of dielectric layers and the plurality of inner electrodes are alternately laminated is manufactured by laminating dielectric layers having the inner electrode patterns and compressing them from a lamination direction to compress the laminated dielectric layers and inner electrode pastes.

Then, as a second stage, the capacitor main body is fired. The firing may be performed at a temperature of 400 to 1500□.

Then, as a third stage, external electrodes are formed such that they cover both lateral surfaces of the capacitor main body and they are electrically connected to exposed portions of the inner electrodes, which are exposed to the both lateral surfaces of the capacitor main body. The external electrodes are formed by coating and firing a metal paste including metal components and organic polymer resin on cross sections of the capacitor main body 12. The external electrode of the present invention may be formed by using a metal selected from Cu, Ni, and Ag.

The organic polymer resin may be formed by coating, hardening and firing a paste including a thermosetting polymer having conductivity, for example, an epoxy resin or the like.

As a fourth stage, electroless plating layers are formed on the external electrodes. The electroless plating layer according to the present invention may be formed by using at least one metal selected from the group consisting of Sn, Ni, Cu, Ag, Co, Au, and Pd. Among them, it is preferable to use Sn having good flexibility to improve flexure strength.

In addition, a pretreatment process may be performed on the external electrodes before the electroless plating layers are formed. The pretreatment process may be performed by three steps of degreasing-soft etching-activating, and at least one of the three steps may be performed. That is to say, the pretreatment process is particularly not limited.

Last, as a fifth stage, plating layers may be formed on the electroless plating layers. The plating layer may be formed in plural layers, and for example, may include a first plating layer made of Ni metal and a second plating layer made of Sn metal.

The plating layer may be formed by using one method selected from electroplating and electroless plating, or both of them.

In addition, according to the present exemplary embodiment, connection electrodes may be further formed on the capacitor main body before the external electrodes are formed. The connection electrodes may be formed for smooth contact between the inner electrodes and the external electrodes.

Hereinafter, the present invention will be described in detail with reference to the examples. The examples of the present invention are provided in order to more completely explain the present invention to those skilled in the art. The following examples may be modified in several different forms and does not limit a scope of the present invention. Rather, these examples are provided in order to make this disclosure more thorough and complete and completely transfer ideas of the present invention to those skilled in the art.

### Example 1

Conductive inner electrodes were respectively printed on dielectric layers prepared by using slurry including a dielectric material. Then, the printed dielectric layers were laminated in a predetermined thickness, to manufacture a capacitor main body, which was then fired.

External electrodes (Ag-epoxy) for electric connection with inner electrodes are coated and hardened/fired on both lateral surfaces of the capacitor main body.

Then, electroless reduction tin (Sn) plating layers with a thickness of 1 μm were formed on the external electrodes. Ni electroplating layers and electroless Sn plating layers were formed on the electroless reduction tin (Sn) plating layers.

### Experimental Example 1

After the electroless reduction tin plating layers of the manufactured multilayer ceramic capacitor was introduced, the number of soldering defects was checked over five times, and the results were tabulated in Table 1. A test picture showing whether or not the soldering defects are present or absent is shown in FIG. 5.

TABLE 1

| | First | Second | Third | Fourth | Fifth |
|---|---|---|---|---|---|
| Number of soldering | 0/1600 | 0/1600 | 0/1600 | 0/1600 | 0/1600 |
| defects | | | | | |

As shown in Table 1, it was confirmed from the results of measuring the number of soldering defects five times that soldering defects were never generated. From these results, it can be seen that the soldering defect problem occurring due to nickel non-plating can be completely solved by forming the electroless plating layer on the external electrode before nickel and tin plating layers are formed. In addition, these results confirmed that nickel plating was more effective when the electroless plating layer is formed on the external electrode and then the nickel plating layer is formed.

Also, it can be confirmed from a picture of FIG. 5 that a clear plating layer is formed without soldering defects.

According to the examples of the present invention, the electroless plating layer is formed before the plating layer is formed on the external electrode, thereby solving non-plating problems when the plating layer made of nickel or the like is formed on the external electrode. Therefore, soldering defects due to nickel non-plating or the like can be solved at the time of mounting, and thus, a multilayer ceramic capacitor having high reliability can be provided.

Further, according to the present invention, the electroless plating layer is formed on the external electrode by using a material having good flexibility, thereby improving flexure strength of the multilayer ceramic capacitor.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic capacitor, comprising:
a capacitor main body having dielectric layers and inner electrodes laminated therein;
external electrodes and plating layers formed on a surface of the capacitor main body; and
electroless plating layers formed between the external electrodes and the plating layers.

2. The multilayer ceramic capacitor according to claim 1, wherein the electroless plating layer has a thickness of 0.1 to 5 μm.

3. The multilayer ceramic capacitor according to claim 1, wherein the electroless plating layer is formed by using at least one metal selected from the group consisting of Sn, Ni, Cu, Ag, Co, Au, and Pd.

4. The multilayer ceramic capacitor according to claim 1, wherein the external electrode is formed by using at least one metal selected from Cu, Ni, and Ag.

5. The multilayer ceramic capacitor according to claim 1, wherein the plating layer is formed to have plural layers including a nickel plating layer and a tin plating layer.

6. The multilayer ceramic capacitor according to claim 1, wherein the plating layer is formed by using one method selected from electroplating and electroless plating, or both of them.

7. The multilayer ceramic capacitor according to claim 1, further comprising connection electrodes formed between the capacitor main body and the external electrodes.

8. The multilayer ceramic capacitor according to claim 7, wherein the connection electrode is formed by using at least one metal selected from Cu, Ni, and Ag.

9. A method for manufacturing a multilayer ceramic capacitor, comprising:
forming a capacitor main body where dielectric layers and inner electrodes are alternately laminated;
firing the capacitor main body;
forming external electrodes on a surface of the capacitor main body;
forming electroless plating layers on the external electrodes; and
forming plating layers on the electroless plating layers.

10. The method according to claim 9, wherein the electroless plating layer is formed by using at least one metal selected from the group consisting of Sn, Ni, Cu, Ag, Co, Au, and Pd.

11. The method according to claim 9, wherein the electroless plating layer has a thickness of 0.1 to 5 μm.

12. The method according to claim 9, further comprising performing a pretreatment process on the external electrodes before the forming of the electroless plating layers.

13. The method according to claim 9, further comprising forming connection electrodes on the capacitor main body before the forming of the external electrodes.
